(19) United States
(12) Patent Application Publication
(10) Pub. No.: US 2014/0253329 A1
(43) Pub. Date: Sep. 11, 2014

(54) Smart Home Defense Chamber (SHDC)

(71) Applicant: Mark Anthony Chavez, Rockwall, TX (US)

(72) Inventor: Mark Anthony Chavez, Rockwall, TX (US)

(21) Appl. No.: 13/787,836

(22) Filed: Mar. 7, 2013

(51) Int. Cl. G08B 13/02; E05G 1/10

(52) U.S. Cl. CPC G08B 13/02; E05G 1/10
USPC 340/541

(57) ABSTRACT

The Smart Home Defense Chamber (SHDC) is a wall chamber that is installed within a wall for the purpose of storing, hiding, securing and protecting firearms and valuables so as to provide an invisible storage chamber that can be equipped with or without a means to alarm to prevent tampering, unauthorized entry and security away from children and thieves. The wall chamber also provides the owner/user an advantageous means of access in the event of an emergency. The SHDC uniqueness is that it is designed and installed to look exactly like the wall it lives within so only the owner/user knows of its location, presence and contents. This allows the owner/user the ability to install many SHDC's in various locations around the home, office or any place they choose without having to worry about unauthorized entry or tampering from children or thieves.

### BACKGROUND OF THE INVENTION

1. Field of the Invention

The present invention relates to a wall chamber that is installed within a wall for the purpose of storing, hiding, securing and protecting firearms and valuables so as it provides an invisible storage chamber that can be equipped with or without a means to alarm to prevent tampering, unauthorized entry and security away from children and thieves. The wall chamber also provides the owner/user an advantageous means of access in the event of an emergency.

2. Description of Prior Art

Wall safes up until today have been only accessible through one side through some means of security such as a key lock, combination or biometric code the primary way of thinking was to keep the guns away from kids and the and the valuables away from burglars, which is still true in today's world with the exception that wall safes of today fall short when it comes to:
1. To alert you in the event your child is trying to access the safe.
2. To alarm in the event of an emergency, such as a break in or home invasion to scare off intruders.
3. Location has always been in one place in the home not throughout the home which makes it hard to keep guns around the house without compromising the security of our families
4. An interface to link up with your current Home monitoring system.
5. Quick access in the event of an emergency. With the current safes of today you have to enter a code or use a key in order to access the safe which can be difficult when you are under extreme pressure or duress.
6. Potential problems with a power outage in the event of an emergency such as difficulty seeing the dial or buttons in darkness, the safe is dead because you forgot to replace the batteries, or the power has been cut.
7. Electronics can be fickle under electro static discharge and access to your safe can be interfered with in this event.
8. Accessible from only one side in case of an emergency and the do not have a means to alert anyone or everyone that the wall safe has been accessed and potentially a gun has been taken out of its secure location by someone not authorized to use the contents of the safe.
9. That the owner is aware of an intruder and is prepared to defend him/herself.
10. The current cost versus the location of a safe in relation to where the safe needs to be placed to be effective in the event of an emergency causes most homeowners to think twice about buying a gun safe. Therefore guns end up being stored in closets and drawers which makes it easily accessible but unsafe.

Currently in today's media we are seeing gun violence on the rise. Crimes are being committed by people or children gaining access to guns from either irresponsible gun owners or through theft. If gun owners had a means to store and protect their weapons these crimes or accidents could have possibly been reported early or potentially prevented. Under the current method of how we store our firearms, we currently have no way to know if and when they have either been tampered with or stolen by children and or thieves. If you add in the potential of a child or adolescent with some kind of personal vendetta or mental illness and you have guns lying around it is a recipe for disaster. Because of this we have created a better way to stow and secure your firearms and valuables which solves these issues but still allows the gun owner or authorized user quick access in case of an emergency. Our product also goes a step further to alarm in the event the safe is accessed under normal use and emergency as well. That way there is never a question as to where and who has access to you guns and valuables.

U.S. Pat. No. 5,111,755 describes A safe gun storage apparatus is disclosed for the storage therein and ready accessibility of a loaded handgun, said storage apparatus having child-deterrent latching apparatus provided therein is disclosed. A gun drawer containing a loaded handgun is retained within a cabinet which is substantially impervious to destruction and being pried open. Dual entry locking apparatus secures the loaded gun with the storage container. A first locking apparatus involving entry of a predetermined key punch code first unlocks a secondary child-deterrent latching apparatus. The latter unlatches after a given sequence of operations are carried out which then unlatches a latching bolt from within an opening provided within the drawer. The accessibility and, therefore, the gun within the drawer is provided in a quiet and otherwise undetectable mode of operation

This equipment is limited and restricted by its location and accessibility. in order for a home owner to have many of these types of safes, they would have to put them in drawers and night stands all over the house. This can be unsafe for children if they somehow find the key or figure out the code. You have no way of knowing whether the safe has been tampered with or if your child could potentially have access to a loaded gun. Also burglars will steal a safe and take it with them so that they can open it later. The current safe in question also relies on first locking apparatus involving entry of predetermined key punch code first unlocks a secondary child-deterrent latching apparatus. This can be problematic in the event of an emergency when you are scared or under fire. You may not remember the code or have enough time to go through the steps required to gain access to your firearm. These types of safes are also restricted to where they can be placed because you want to keep them a secret but a safe in the drawer sticks out so it will attract attention from either children or thieves. It could also be on the opposite site of the house when an emergency happens so you may not even have a chance to get to it in the event you need it.

U.S. Pat. No. 5,513,580 discloses a method for lockbox or safe for storing possessions, which can be installed in a closet in a manner that requires opening the lockbox before it can be removed from the closet. This is done by providing one or more extensions (such as side walls, rigid shafts, or end caps) that can be extended outwardly from either or both sides of the lockbox. When retracted, the lockbox has dimensions that allow it to be inserted into the closet through the closet door. After it is positioned on the floor of the closet, the compartment door is opened. This provides access to a mechanism that controls the positioning of the extensions, such as bolts or cotter pins that interact with multiple spaced holes in sliding mechanisms. The extension locking mechanism is unlocked, and the extensions are pushed outwardly until they press against the side walls of the closet. As long as the lockbox remains locked, the extensions pressing against the side walls of the closet will prevent the lockbox from being removed from the closet, unless the door jamb-and/or closet wails are destroyed. Since such destruction is beyond the capability and desire of most thieves, the lockbox and its valuables will be secure against most attempted break-ins. For homes or apartments, these lockboxes can also be screwed or bolted to the floor or wall of a closet, using screws or bolts that can be removed only when the lockbox is open. These lockboxes can also be secured in a similar manner inside automobile trunks.

This method is limited to its location since it has to be installed in an area where no one will see it. It will most likely not be accessible during a home emergency especially if you are not on that side of the house. This method of invention is also a target for a burglar because once they see it time permitting they will tear it off the wall and take it with them so they can open it later. This method also has no means of alarming in the event a child tampers with it so if you leave the key around some where your child could potentially gain access to the contents.

U.S. Pat. No. 4,890,466 discloses a method for An improved apparatus to lock a handgun within a compartment while the compartment is readily lockable to a stationary object using a detachable bracket. The compartment is only accessible by authorized persons selecting a particular code which unlocks a hitch to open the compartment. The bracket can only be detached when the apparatus is in an open position. The latch can he lighted to allow the selecting of the proper code in darkness. The apparatus also serves to carry the handgun and can be subsequently used to so secure the handgun at another location.

This method is limited because it only serves as a lockbox for a firearm and has no real means of invisibility. It is also reliant on another cabinet to mask its presence. If the box were to be discovered a burglar would simply just take it and open it later. This method does not hake a means to alarm in the event it is tampered with or broken into.

### SUMMARY OF THE INVENTION

Our Smart Home Defense Chamber (SHDC) uses a fire resistant material sized for mounting flush within a wall and formed with a frame To receive a specially constructed panel equipped with a means to alarm when shattered, dented or altered by an intentional means of force and or normal access. The access panel when put in place is used to disguise the SHDC's location and contents once put in place it is then taped and textured to match the wall surface so that only the user and authorized person or persons know of its location. The SHDC chamber can also be accessible through both sides of the wall if the user chooses to install the SHDC without the back panel so when inserted into a wall cavity the back side of the SHDC can be accessed by breaking through either SHDC panels to gain access to your weapons or valuables in case of an emergency. Both means of access are controlled and monitored by an onboard alarm and fire safety system to prevent tampering and non-authorized entry. The alarm feature for the emergency access door is a specially constructed panel or material that can be installed and or applied to any other surface the user chooses to disguise the sale with. Once the panel is broken the emergency alarm is triggered and an alarm message is continually played until the user resets the alarm. This SHDC can be configured to work with home monitoring services to alert the authorities of a break in or tampering. The SHDC can also be configured to have a hidden access door to be accessed through a means of a locking system such as a combo, biometric, magnetic, or key lock. The benefit of our access door is that it is hidden with in the wall cavity behind a specially designed wall fixture such as a light switch or electrical plug that is specially designed to move out of the way when the user wants to gain normal access the SHDC chamber for routine maintenance. The specially designed wall fixture is equipped with a means of security as well such as a special keyed fastener that has to be unfastened to prevent tampering and unauthorized access to the access door which is also equipped with a means to lock and alarm whenever accessed so as to alert everyone that a SHDC chamber has been accessed.

It is therefore the primary object of the present invention to provide a Smart Home Defense Chamber which will significantly improve the way gun owner stow firearms around their home in a manner that is both safe from children, completely invisible to non-authorized users and thieves, alarmed and advantageous for the unprepared home owner in the event a home invasion occurs when the would need to protect themselves or their families.

It is another object of the present invention, to provide a cost effective means so that gun owners will be able to afford multiple Smart Home Defense Chambers that they can install throughout their home to provide complete home protection.

### BRIEF DESCRIPTION OF THE DRAWINGS

FIG. 1 is a front sectional view looking into the SHDC-NA (no access) chamber showing that this installation only has one means of access according to the present invention.

FIG. 2 is a front, back and side sectional view of the breakable alarm and according to the present invention.

FIG. 3 is a sectional view of the breakable adhesive back alarm mesh that can be applied to any surface according to the present invention.

FIG. 4 is a front sectional view of the SHDC-DA (dual access) showing that the chamber can be accessed from both sides of a wall according to the present invention.

FIG. 5 SHDC-HA (hidden access) is a front sectional view showing a uniquely designed switch box capable of disguising itself and working as an everyday common switch for a fixture. The switch is also equipped to be moved out of the way to reveal a locked access point for the SHDC-HA to insure security and invisibility.

### DETAILED DESCRIPTION OF THE INVENTION

1. Definitions
Owner, User, or Authorized user: from here on in to mean a person or persons authorized to know of the existence and location of the SHDC and its contents and is permitted to use the SHDC and its contents.
SHDC: is to be the abbreviation for the Smart Home Defense Chamber
SHDC-NA: is the abbreviation for the Smart Home Defense Chamber—No Access meaning that the chamber only has one means of access which is emergency access.
SHDC-HA: is the abbreviation for the Smart Home Defense Chamber—Hidden Access meaning that the chamber has another means of access through a hidden entry point.
Safe: Any reference to the word “Safe” is to be considered a past invention invented and by someone or some other company not to be confused with my invention, the SHDC (Smart Home Defense Chamber)

2. Best Mode of the Invention

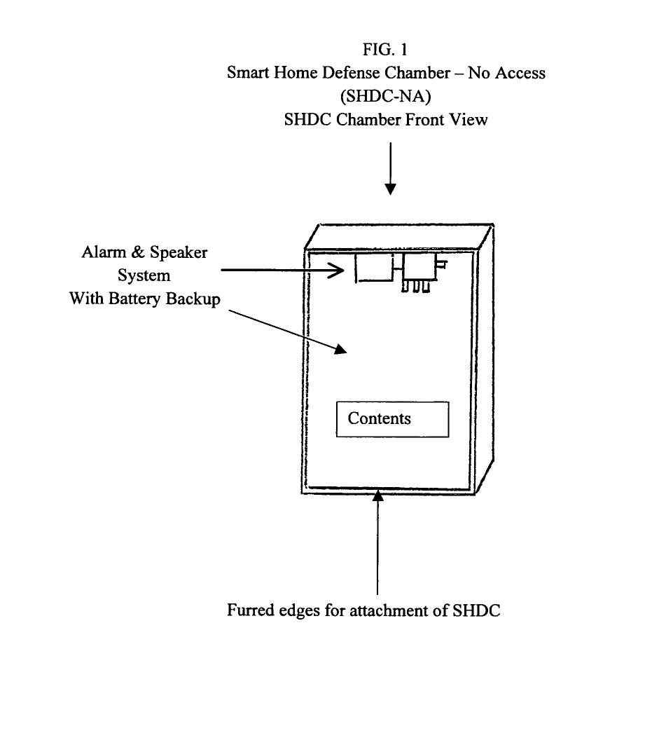

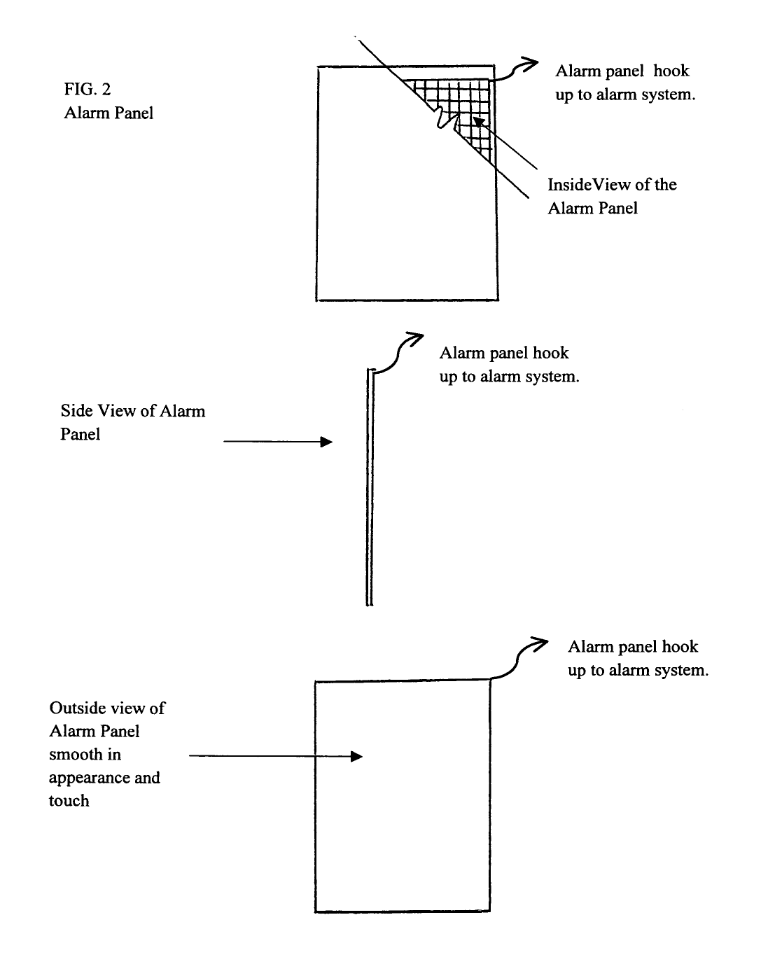

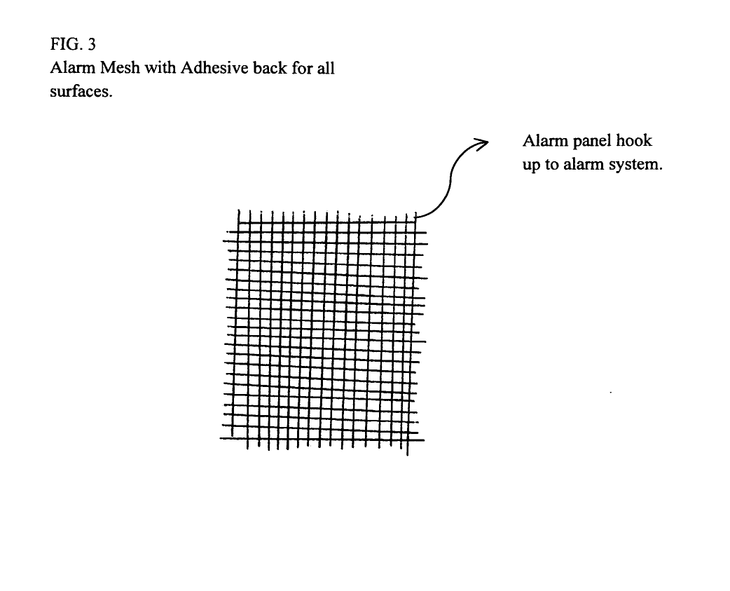

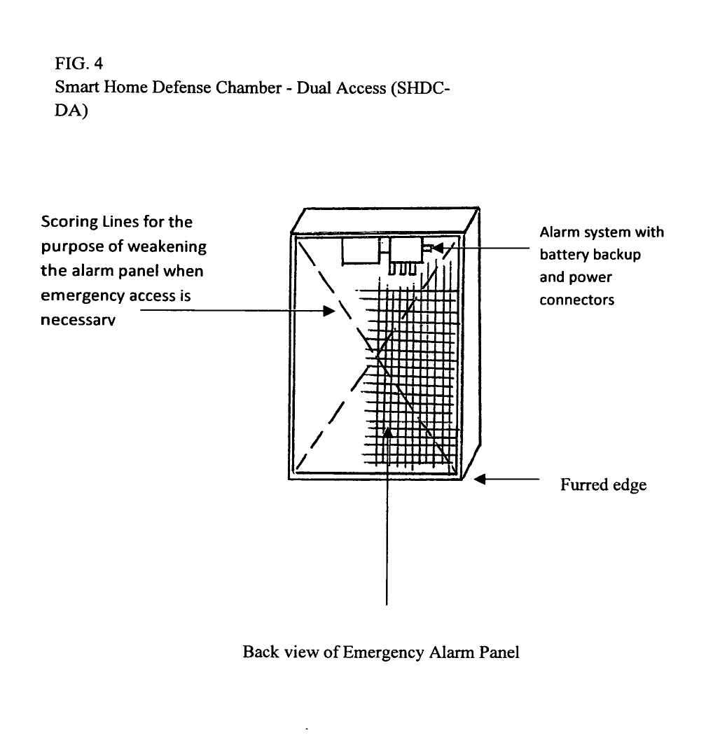

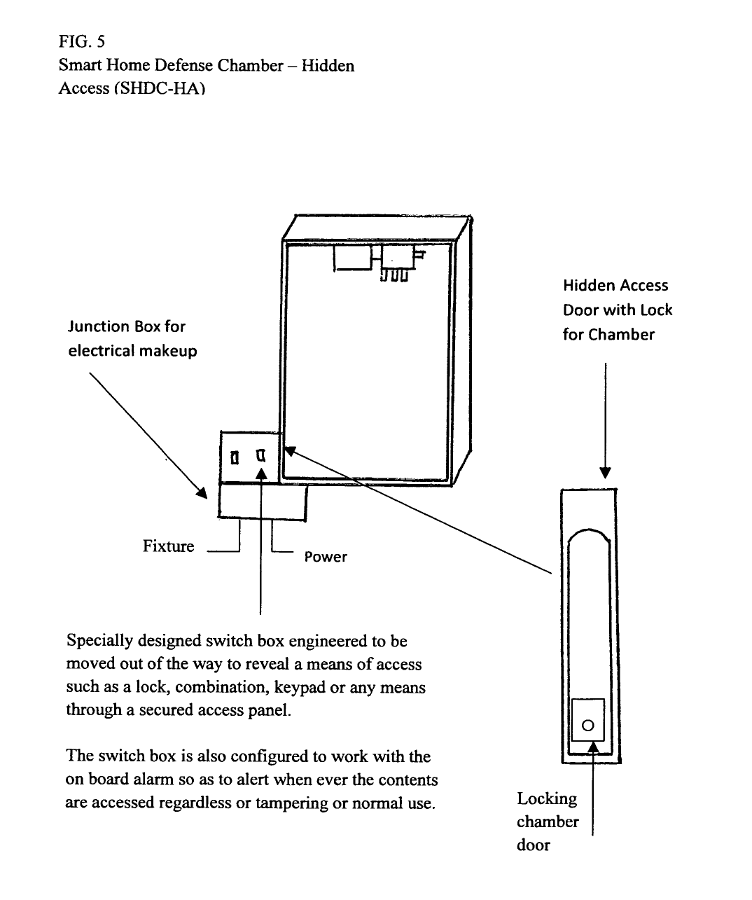

FIGS. 1-5 shows side sectional views of the best mode contemplated by the inventor of the Smart Home Defense Chamber according to the concepts of the present invention.

As can be amply seen from the drawings, the Smart Home Defense Chamber is built out of a means of fire resistant material in different widths, lengths, and debts to adapt to the cavity of any wall space not all homes or building share the same thickness of all so our SHDC chamber can be configured to accommodate different wall thicknesses. For the purpose that all guns are not the same in length, so is true of the size of the Smart Home Defense Chamber SHDC which can be larger as well. The alarm panel is made of a breakable material to aid in the ease or breaking the panel in the event the owner or authorized user needs to gain access to the chamber at any given time. The panel for the chamber is also equipped with a means to alarm in the event the panel is intentionally or accidentally tampered with to alert anyone in hearing distance that something out of the ordinary is happening. For people that do not know about the SHDC they will just think it is a burglar alarm, but for the owner or authorized users they will immediately know that a SHDC chamber has been accessed and a potential emergency is taking place. This invention can be made in 3 different ways to allow the owner to choose what type of features be or she wants. The first way is simply just the SHDC-NA (No Access) box. The owner can elect to hookup the alarm panel or not in this installation. This installation does not have a normal access door so after the alarm panel has been installed the chamber is completely secure. The only way to access the SHDC chamber at the point is to break through the alarm panel under emergency access.

The second mode of construction/installation provides for a means of access through a hidden normal access door which carries a means to be secured, locked and alarmed so that the user can have secured access to the SHDC chamber when necessary. The owner can elect to not hook up the alarm panel. However the alarm system for the SHCD-HA (Hidden Access) chamber can be installed with a means to alarm under emergency access when the alarm panel is broken into or also under a lesser alarm for normal access when the normal access door is opened under normal access.

The third mode of construction/installation provides for a means for dual access where the chamber is built using a fire resistant box with only the interior side walls to secure it inside the wall structure. In this mode the front and back panels are both alarm panels giving the owner dual access from either side of the wall. Either of the SHDC-NA or the SHDC-HA can be configured this way by removing the back panel from the SHDC chamber. All SHDC chamber alarm panels are equipped with alarm technology. All the user needs to do is plug the alarm panels leads into the alarm controller and install the alarm controller into a power source such as a switch or plug. If a power source is not available the alarm panels can be run off of the battery backup system as the primary power source. The user will then just have to change the battery over time as it wears out.
4. Examples
5. How to Use the Invention

The problem address by the Smart Home Defense Chamber are many as can be seen by those skilled in this art. The Smart Home Defense Chamber increases the ability to store guns safely anywhere in the home while increasing security and accessibility in the event of an emergency. The Smart Home Defense Chamber is the only storage solution that can be installed anywhere in the home in which only the owner and authorized users will know of its presence. The Smart Home Defense Chamber is the only storage system that is equipped with an alarm system that acts as much of a deterrent as the contents of the chamber. The Smart Home Defense Chamber is the only true child safe and burglar free system because children and burglars will not even know of its presence. The Smart Home Defense Chamber is the only storage system that has a tattle tale feature where it will notify you if the chamber is being opened. The Smart Home Defense Chamber is the only storage system that gives the owner emergency access without having to use some means of a locking system in the event of an emergency. The Smart Home Defense Chamber is the only chamber that cull potentially save lives because in the event of an emergency when seconds count and location matters you have the ability to be prepared in any room in your home, office or building. How much better off today would we be if we had this system already installed where we have currently seen violence such as in schools, mails, campus's, and corporate buildings?

Thus it will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A alarmed emergency access Smart Home Defense Chamber SHDC comprising: a chamber made of fire resistant material sized for the purpose of installing within a wall to store firearms and valuables for quick access in the event of an emergency; a panel equipped with a means to alarm is then applied to the exterior of the chamber to enclose the contents of the chamber; the alarm panel is made of similar material to look and feel like the surrounding wall structure to insure the invisibility of the chamber; since the chamber wall or alarm panel looks just like the surrounding wall only the owner/authorized user knows of its location, contents and presence;

2. A Smart Home Defense Chamber according to claim 1 is made from a hardened fire resistant material sized to fit inside of a wall cavity.

3. A Smart Home Defense Chamber according to claim 1 is designed to look exactly like the wall it lives within in order to eliminate tampering from children and non-authorized persons.
a. A supporting claim to the invisibility design is since no one can see the cabinet due to the fact that they are unaware of the Smart Home Defense Chamber SHDCs location and because it blends in with the wall, this gives you the ability to place these Smart Home Defense Chamber SHDCs all over your house in many locations so you always be prepared no matter where you are in home or office.
b. Because of the invisibility and anonymity of the Smart Home Defense Chamber SHDC's, they are safe from children and non-authorized people because they do not know about the location of the Smart Home Defense Chamber SHDC's. All the Smart Home Defense Chamber SHDC's can be equipped with an alarm system so if they are tampered with, you are immediately notified by a means of, alarms, hearing, sight, visual damage, mobile, internet and home monitoring notifications.

4. A Smart Home Defense Chamber according to claim 1 provides for a means of dual access through either side of a wall.

5. A Smart Home Defense Chamber has a means of alarmed access; one being normal access and the other being emergency access.

6. A Smart Home Defense Chamber according to claim 5 alarm system serves two purposes.
a. Normal Access: Alert the user/owner of normal access to the safe. When the safe is accessed under normal mode through the access door, a low tone alarm will sound so that the user and other parties around will know that the safe has been accessed. If the user so decides be or she can set off the emergency alarm from inside the safe to scare off potential intruders if need be while they get their weapons ready for a potential confrontation.
b. Emergency Access: A High alarm is set off to deter potential intruders and to notify everyone that an emergency is taking place and the owner/user is armed and prepared. This is normally accomplished when the owner/authorized user breaks through or into the alarm panel to access their contents in an emergency.

7. A Smart Home Defense Chamber according to claim 5 can be used with or without hooking up the alarm system.

8. A Smart Home Defense Chamber according to claim 5 when equipped uses a means to notify the user/owner of normal access and/or emergency access even if they are away from the location where the SHDC is installed.

9. A Smart Home Defense Chamber according to claim 5 can act as a means of passage from one room to another in the event of an emergency under emergency access.

10. A Smart Home Defense Chamber can be configured and installed in different ways with multiple features.

11. A Smart Home Defense Chamber according to claim 10 when equipped has a means of normal access through a specially designed electrical fixture to hide an internal access door carrying a locking device so as to give the owner/authorized user access to the contents inside the SHDC chamber.

12. A Smart Home Defense Chamber according to claim 10 Chamber when equipped can be hooked into a preexisting electrical fixture as a hardwired device.

13. A Smart Home Defense Chamber according to claim 10 can be configured to work off of a battery source when hardwired electrical service is not available.

14. A Smart Home Defense Chamber according to claim 10 can use a false \electrical fixture installed near the SHDC to conceal a battery pack or other alarm system features if the SHDC is to be a non-access chamber so as to make the maintenance of the chamber easier and more efficient.

15. A Smart Home Defense Chamber according to claim 10 can be equipped to work with all of today's Home Monitoring Services.

16. A Smart Home Defense Chamber according to claim 10 can be equipped to work with Wi-Fi and Bluetooth technology.

17. A Smart Home Defense Chamber according to claim 10 can be installed by a certified technician or the owner of the SHDC chamber

18. A Smart Home Defense Chamber according to claim 10 the alarm panel can be adhered to any surface in the event, the Chamber is not going into a wall where the outside surface would differ in appearance so as to adapt to its environment.

19. A Smart Home Defense Chamber according to claim 10 can be made of sizeable box that can be expanded or collapsed by a means of mechanical gears to allow the installer a means to install the SHDC inside the cavity of a wall structure without having to damage the wall.

20. A Smart Home Defense Chamber according to claim 10 can be equipped with a means to photograph, video and record both normal and emergency access.
